(19) United States
(12) Patent Application Publication
(10) Pub. No.: US 2022/0105802 A1
(43) Pub. Date: Apr. 7, 2022

(54) ELECTRONIC DEVICE AND VEHICLE INCLUDING SAME

(71) Applicant: Samsung Electronics Co., Ltd., Suwon-si, Gyeonggi-do (KR)

(72) Inventors: Kyung Ho JEONG, Seongnam-si (KR); Yoon Su KIM, Seoul (KR); Jae Seok MYUNG, Siheung-si (KR); Sahng Hee BAHN, Yongin-si (KR); Young Kyu JIN, Seoul (KR)

(21) Appl. No.: 16/476,433

(22) PCT Filed: Jan. 9, 2018
(86) PCT No.: PCT/KR2018/000435

§ 371 Date: Jul. 8, 2019

(30) Foreign Application Priority Data
Jan. 10, 2017 (KR) 10-2017-0003282

(51) Int. Cl. B60K 35/00

(52) U.S. Cl. CPC B60K 35/00; B60K 2370/73; B60K 2370/67; B60K 2370/1533

(57) ABSTRACT

An electronic device included in at least one area inside a vehicle includes a display that has at least one area including a flexible characteristic, a memory that stores at least one application program, an actuator module that supports shape deformation of the at least one area of the display, and a processor that is electrically connected to the display, the memory, and the actuator module. The processor determines a position of at least one user in the vehicle and performs control to deform the at least one area of the display in a direction corresponding to the position of the user, when a specified requirement is satisfied with regard to the shape deformation of the at least one area of the display. Besides, it may be permissible to prepare various other embodiments speculated through the specification.

### TECHNICAL FIELD

Various embodiments of the disclosure described herein relate to a technology for operating a display of an electronic device mounted in a vehicle.

### BACKGROUND ART

In recent years, with the widespread use of electronic devices equipped with independent operating systems, the electronic devices have provided various functions or services aiming for interactions with users. Accordingly, the importance of displays that function as interfaces between the electronic devices and the users has been emphasized, and various forms of displays in which the most advanced technologies are integrated have been proposed. A flexible display that is deformed by physical force of a specified magnitude may be given as an example of the displays.

### DISCLOSURE

### Technical Problem

The flexible display may be implemented as a central information display or a cluster in a vehicle to provide various types of information or contents accompanying travel of the vehicle. However, the flexible display applied to the vehicle has a standardized shape or is fixed in a specific shape, and therefore an occupant's viewing angle for the display may not be taken into account.

Various embodiments of the disclosure provide an electronic device for deforming at least one area of a display based on the position of a user in a vehicle to improve the user's readability for contents displayed on the display, and a vehicle including the electronic device.

### Technical Solution

An electronic device included in at least one area inside a vehicle according to an embodiment includes a display having at least one area including a flexible characteristic, a memory that stores at least one application program, an actuator module that supports shape deformation of the at least one area of the display, and a processor electrically connected to the display, the memory, and the actuator module.

According to an embodiment, the processor may determine a position of at least one user in the vehicle and may perform control to deform the at least one area of the display in a direction corresponding to the position of the user, when a specified requirement is satisfied with regard to the shape deformation of the at least one area of the display.

### Advantageous Effects

According to various embodiments, the electronic device may deform the at least one area of the display in the direction corresponding to the position of the user, thereby optimizing the user's viewing angle for the display.

According to various embodiments, the electronic device may support easy access of the user to a control area (e.g., a software input panel (SIP) keyboard or the like) of the display, based on the shape deformation of the display.

According to various embodiments, the electronic device may deform the shape of the display according to the travel speed of the vehicle, thereby improving the user's readability for various types of information displayed on the display.

In addition, the disclosure may provide various effects that are directly or indirectly recognized.

### DESCRIPTION OF DRAWINGS

FIG. 1 is a view illustrating an operating environment of an electronic device according to an embodiment.

FIG. 2 is a view illustrating a configuration of the electronic device according to an embodiment.

FIGS. 3A and 3B are views illustrating a structural form related to shape deformation of a display according to an embodiment.

FIG. 4 is a view illustrating determination of the position of a user according to an embodiment.

FIG. 5A is a view illustrating a first shape of the display according to an embodiment.

FIG. 5B is a view illustrating a second shape of the display according to an embodiment.

FIG. 5C is a view illustrating a third shape of the display according to an embodiment.

FIG. 6 is a view illustrating a series of processes for shape deformation of the display according to an embodiment.

FIG. 7A is a view illustrating a first shape of the display according to another embodiment.

FIG. 7B is a view illustrating a second shape of the display according to another embodiment.

FIG. 8A is a view illustrating a first shape of the display according to yet another embodiment.

FIG. 8B is a view illustrating a second shape of the display according to yet another embodiment.

FIG. 9 is a view illustrating an electronic device in a network environment according to an embodiment.

FIG. 10 is a view illustrating a block diagram of an electronic device according to an embodiment.

FIG. 11 is a view illustrating a block diagram of a program module according to an embodiment.

In regard to descriptions of the drawings, the identical or equivalent component may be designated by the identical reference numeral.

### MODE FOR INVENTION

Hereinafter, various embodiments of the present disclosure are disclosed with reference to the accompanying drawings. However, the present disclosure is not intended to be limited by the various embodiments of the present disclosure to a specific embodiment and it is intended that the present disclosure covers all modifications, equivalents, and/or alternatives of the present disclosure provided they come within the scope of the appended claims and their equivalents. With respect to the descriptions of the accompanying drawings, like reference numerals refer to like elements.

The term “include,” “comprise,” and “have”, or “may include,” or “may comprise” and “may have” used herein indicates disclosed functions, operations, or existence of elements but does not exclude other functions, operations or elements.

For example, the expressions “A or B,” or “at least one of A and/or B” may indicate A and B, A, or B. For instance, the expression “A or B” or “at least one of A and/or B” may indicate (1) at least one A, (2) at least one B, or (3) both at least one A and at least one B.

The terms such as “1st,” “2nd,” “first,” “second,” and the like used herein may refer to modifying various different elements of various embodiments of the present disclosure, but are not intended to limit the elements. For instance, “a first user device” and “a second user device” may indicate different user devices regardless of order or importance. For example, a first component may be referred to as a second component and vice versa without departing from the scope of the present disclosure.

In various embodiments of the present disclosure, it is intended that when a component (for example, a first component) is referred to as being “operatively or communicatively coupled with/to” or “connected to” another component (for example, a second component), the component may be directly connected to the other component or connected through another component (for example, a third component). In various embodiments of the present disclosure, it is intended that when a component (for example, a first component) is referred to as being “directly connected to” or “directly accessed” another component (for example, a second component), another component (for example, a third component) does not exist between the component (for example, the first component) and the other component (for example, the second component).

The expression “configured to” used in various embodiments of the present disclosure may be interchangeably used with “suitable for,” “having the capacity to,” “designed to,” “adapted to,” “made to,” or “capable of” according to the situation, for example. The term “configured to” may not necessarily indicate “specifically designed to” in terms of hardware. Instead, the expression “a device configured to” in some situations may indicate that the device and another device or part are “capable of.” For example, the expression “a processor configured to perform A, B, and C” may indicate a dedicated processor (for example, an embedded processor) for performing a corresponding operation or a general purpose processor (for example, a central processing unit (CPU) or application processor (AP)) for performing corresponding operations by executing at least one software program stored in a memory device.

Terms used in various embodiments of the present disclosure are used to describe certain embodiments of the present disclosure, but are not intended to limit the scope of other embodiments. The terms of a singular form may include plural forms unless they have a clearly different meaning in the context. Otherwise, all terms used herein may have the same meanings that are generally understood by a person skilled in the art. In general, terms defined in a dictionary should be considered to have the same meanings as the contextual meaning of the related art, and, unless clearly defined herein, should not be understood differently or as having an excessively formal meaning. In any case, even the terms defined in the present specification are not intended to be interpreted as excluding embodiments of the present disclosure.

An electronic device according to various embodiments of the present disclosure may include at least one of a smartphone, a tablet personal computer (PC), a mobile phone, a video telephone, an electronic book reader, a desktop PC, a laptop PC, a netbook computer, a workstation, a server, a personal digital assistant (PDA), a portable multimedia player (PMP), a Motion Picture Experts Group (MPEG-1 or MPEG-2) Audio Layer 3 (MP3) player, a mobile medical device, a camera, or a wearable device. The wearable device may include at least one of an accessory-type device (e.g., a watch, a ring, a bracelet, an anklet, a necklace, glasses, a contact lens, a head-mounted device (HMD)), a textile- or clothing-integrated-type device (e.g., an electronic apparel), a body-attached-type device (e.g., a skin pad or a tattoo), or a bio-implantable-type device (e.g., an implantable circuit).

In some various embodiments of the present disclosure, an electronic device may be a home appliance. The smart home appliance may include at least one of, for example, a television (TV), a digital video/versatile disc (DVD) player, an audio, a refrigerator, an air conditioner, a cleaner, an oven, a microwave oven, a washing machine, an air cleaner, a set-top box, a home automation control panel, a security control panel, a television (TV) box (e.g., Samsung HomeSync™, Apple TV™, or Google TV™), a game console (e.g., Xbox™ or PlayStation™), an electronic dictionary, an electronic key, a camcorder, or an electronic picture frame.

In other various embodiments of the present disclosure, an electronic device may include at least one of various medical devices (e.g., various portable medical measurement devices (e.g., a blood glucose measuring device, a heart rate measuring device, a blood pressure measuring device, a body temperature measuring device, or the like), a magnetic resonance angiography (MRA) device, a magnetic resonance imaging (MRI) device, a computed tomography (CT) device, a scanner, an ultrasonic device, or the like), a navigation device, a global navigation satellite system (GNSS), an event data recorder (EDR), a flight data recorder (FDR), a vehicle infotainment device, electronic equipment for vessels (e.g., a navigation system, a gyrocompass, or the like), avionics, a security device, a head unit for a vehicle, an industrial or home robot, an automatic teller machine (ATM), a point of sales (POS) device of a store, or an Internet of things (IoT) device (e.g., a light bulb, various sensors, an electric or gas meter, a sprinkler, a fire alarm, a thermostat, a streetlamp, a toaster, exercise equipment, a hot water tank, a heater, a boiler, or the like).

According to various embodiments of the present disclosure, an electronic device may include at least one of a part of furniture or a building/structure, an electronic board, an electronic signature receiving device, a projector, or a measuring instrument (e.g., a water meter, an electricity meter, a gas meter, a wave meter, or the like). An electronic device may be one or more combinations of the above-mentioned devices. An electronic device according to some various embodiments of the present disclosure may be a flexible device. An electronic device according to an embodiment of the present disclosure is not limited to the above-mentioned devices, and may include new electronic devices with the development of new technology.

Hereinafter, an electronic device according to various embodiments of the present disclosure will be described in more detail with reference to the accompanying drawings. The term “user” used herein may refer to a person who uses an electronic device or may refer to a device (e.g., an artificial intelligence electronic device) that uses an electronic device.

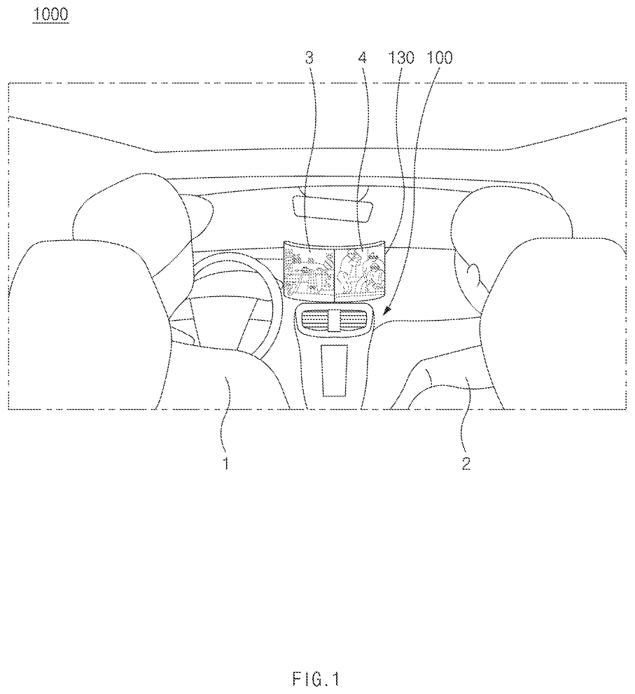

FIG. 1 is a view illustrating an operating environment of an electronic device according to an embodiment.

Referring to FIG. 1, the electronic device 100 may be disposed in at least one area inside a vehicle 1000. For example, the electronic device 100 may be disposed in a front area with respect to at least one first-row seat (e.g., the driver's seat and the front passenger seat) in the vehicle 1000. In an embodiment, the electronic device 100 may be mounted in a specific interface (e.g., the dashboard, the center fascia, or the like) that is associated with operating functions of the vehicle 1000, or may be implemented as the specific interface itself.

In an embodiment, the electronic device 100 may include a display 130 that supports visually outputting contents related to travel of the vehicle 1000 or various types of infotainment contents. At least one area of the display 130 may include a flexible characteristic and may be deformed (e.g., bent) according to a specified requirement in the vehicle 1000. For example, when at least one user (or, occupant) in the vehicle 1000 controls the playback of any contents based on the display 130, the at least one area of the display 130 may be deformed in the direction corresponding to the position of the user.

For example, a first user 1 (e.g., the driver) in the vehicle 1000 may control the electronic device 100 to play first contents (e.g., navigation contents) related to travel of the vehicle 1000 on the display 130. In this case, the electronic device 100 may obtain the position of the first user 1 in the vehicle 1000, and based on the obtained position information, the electronic device 100 may perform control to deform the at least one area of the display 130 toward the first user 1.

In another example, in the operation of playing the first contents on the display 130 by the control of the first user 1, a second user 2 located in a different area from the first user 1 may play second contents (e.g., multimedia contents) including visual information on the display 130. In this case, the electronic device 100 may control another shape deformation of the display 130, the at least one area of which is deformed toward the first user 1. In this regard, the electronic device 100 may divide the screen area of the display 130 into a plurality of virtual areas 3 and 4, based on the properties of the first contents and the second contents (e.g., the types of the contents or the screen aspect ratios of the contents). The electronic device 100 may perform control to deform at least a portion of a first area 3 relatively adjacent to the first user 1 toward the first user 1 and may correspondingly perform control to deform at least a portion of a second area 4 relatively adjacent to the second user 2 toward the second user 2. In this case, the first contents by the control of the first user 1 may be displayed on the deformed first area 3 of the display 130, and the second contents by the control of the second user 2 may be displayed on the second area 4.

As described above, when at least one user in the vehicle 1000 controls the playback of contents, the electronic device 100 may determine the position of the user and may perform control to deform at least one area of the display 130 to correspond to the position of the user. In various embodiments, the shape deformation of the display 130 according to the control of the electronic device 100 is not limited to the environment of the vehicle 1000 illustrated in FIG. 1 and may be applied to various spatial environments accompanied by operation of the display 130, in addition to the environment of the vehicle 1000. Hereinafter, various embodiments related to shape deformation of the display 130 and functional operations of components of the electronic device 100 that implement the embodiments will be described.

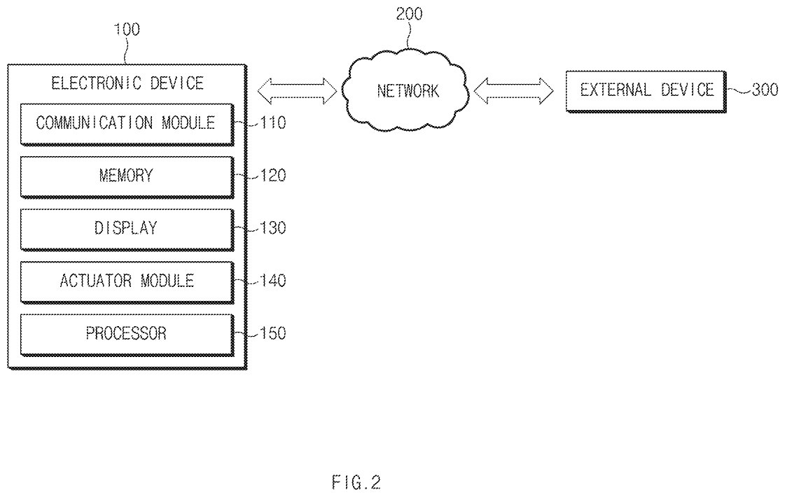

FIG. 2 is a view illustrating a configuration of the electronic device according to an embodiment.

Referring to FIG. 2, the electronic device 100 may interact with at least one external device 300 by constructing a network 200. For example, based on access to the network 200, the electronic device 100 may obtain at least one piece of information relating to operation of the display 130 from the at least one external device 300. In various embodiments, the external device 300 may include at least one of at least one beacon device disposed in at least one area inside the vehicle (1000 of FIG. 1), a server that supports operating an infotainment function of the vehicle 1000, or a mobile device of at least one user in the vehicle 1000.

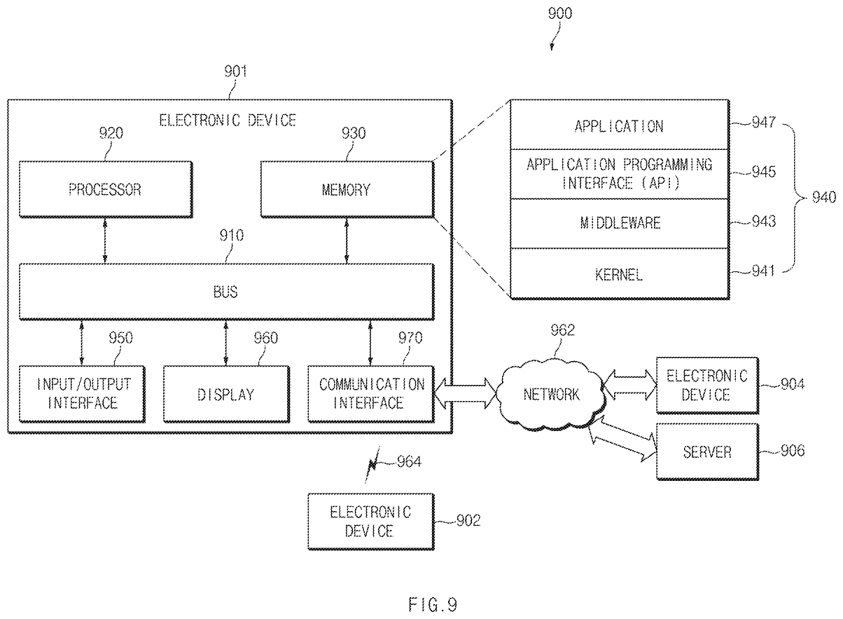

According to an embodiment, the electronic device 100 may include a communication module 110, a memory 120, the display 130, an actuator module 140, and a processor 150. According to various embodiments, the electronic device 100 may not include at least one of the aforementioned components, or may further include other component(s). For example, the electronic device 100 may further include a power supply device (e.g., a battery) that supplies driving power to the components, a camera module that takes an image (e.g., a still image, a video, or the like) of surroundings of the electronic device 100, or the like. Alternatively, the electronic device 100 may further include components of an electronic device 901 that will be mentioned below with reference to FIG. 9.

In an embodiment, the communication module 110 may access the network 200 by performing wired communication or wireless communication. Based on the access to the network 200, the communication module 110 may receive various types of information from the at least one external device 300. For example, the communication module 110 may receive, from the beacon device, position information of a mobile device of at least one user in the vehicle 1000. Alternatively, the communication module 110 may receive at least one piece of contents data transmitted from the mobile device by the control of the user, or may receive at least one piece of contents data from an external server in communication with the vehicle 1000.

In an embodiment, the memory 120 may store at least one piece of data associated with functional operations of the electronic device 100, or may store at least one command related to functional operations of the components of the electronic device 100. For example, the memory 120 may store position information of a mobile device (or, position information of a user having the mobile device) that is received from the beacon device, or contents data received from at least one of the mobile device or the external server. The memory 120 may load stored contents data in response to a user input that is applied to the display 130 or a specific interface (e.g., the center fascia) in the vehicle 1000 and may include at least one application program that supports outputting the loaded contents data.

In an embodiment, the display 130 may output at least one piece of content that is associated with travel of the vehicle 1000 or various infotainment function operations. According to an embodiment, in the operation of displaying the at least one piece of content on the screen, at least one area of the display 130 may be deformed under the control of the processor 150 (or, the actuator module 140). For example, when the playback of contents is controlled by a user in the vehicle 1000, the at least one area of the display 130 may be deformed to correspond to the position of the user, and therefore the display 130 may support easily viewing the contents by the user. In this regard, the at least one area of the display 130 may include a flexible characteristic. In various embodiments, in regard to prevention of physical damage caused by an external impact, the display 130 may be mounted in a housing (e.g., a housing made of rubber), at least one area of which has a specified magnitude of flexibility.

In an embodiment, the actuator module 140 may operate under the control of the processor 150 to support shape deformation of the display 130. In this regard, the actuator module 140 may include a motor and at least one frame. In an embodiment, one end of the frame may be electrically or physically connected with the motor, and an opposite end of the frame may be brought into contact with the rear surface of the display 130. For example, the opposite end of the frame may be propelled in a specified direction (e.g., forward with respect to the display 130) by the motor to apply physical force to the area brought into contact with the display 130, thereby deforming the shape of the display 130.

In an embodiment, the processor 150 may be electrically or operatively connected with the other components of the electronic device 100 and may perform control, communication operations, data processing, or the like for the components. For example, based on position information of at least one user in the vehicle 1000, the processor 150 may control the actuator module 140 to deform the shape of the display 130 to correspond to the position of the user. In this regard, when receiving signals related to contents playback control from at least one user, the processor 150 may determine the number of users and the properties of contents controlled to be played by the users (e.g., the types of the contents, the screen aspect ratios of the contents, or the like) and may divide the screen area of the display 130 into a plurality of virtual areas. The processor 150 may control the actuator module 140 to deform the shape of the display 130 such that boundaries between the virtual areas are bent.

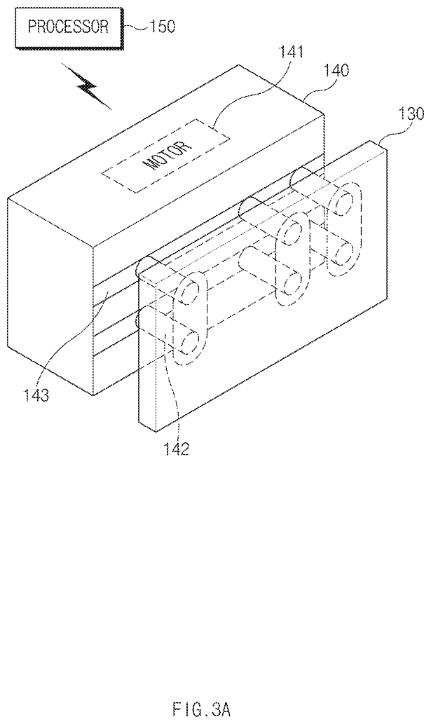

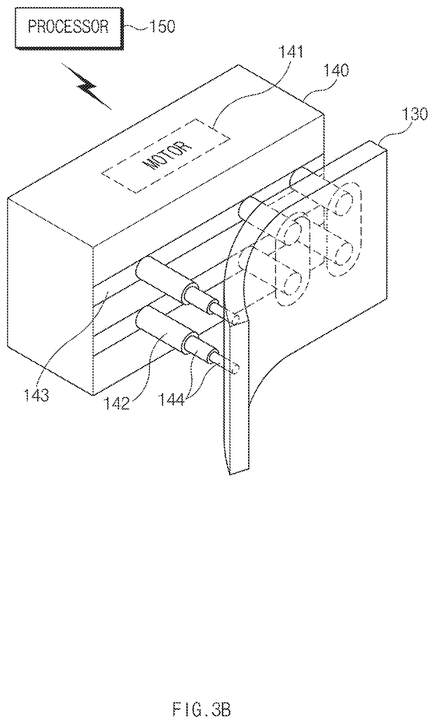

FIGS. 3A and 3B are views illustrating a structural form related to shape deformation of the display according to an embodiment.

Referring to FIG. 3A, the actuator module 140 of the electronic device (100 of FIG. 2) may include a motor 141 and at least one main frame 142. The at least one main frame 142 may operate based on power energy of the motor 141 that is driven under the control of the processor 150, and may support shape deformation of at least one area of the display 130. In this regard, one end of the at least one main frame 142 may be electrically or physically connected with the motor 141, and an opposite end of the at least one main frame 142 may be brought into contact with the rear surface of the display 130. In an embodiment, the at least one main frame 142 may include a pair of upper and lower frames and may move in the lengthwise direction on at least one rail 143 included in the actuator module 140.

Referring to FIGS. 3A and 3B, the at least one main frame 142 may include at least one sub-frame 144 inserted into the at least one main frame 142. In an embodiment, when the main frame 142 operates, the at least one sub-frame 144 inserted may be propelled forward with respect to the display 130 by a spring action. Accordingly, the at least one sub-frame 144 propelled may apply pressure to the rear surface area of the display 130, and at least one area of the display 130 to which the pressure is applied may be deformed (e.g., bent) forward.

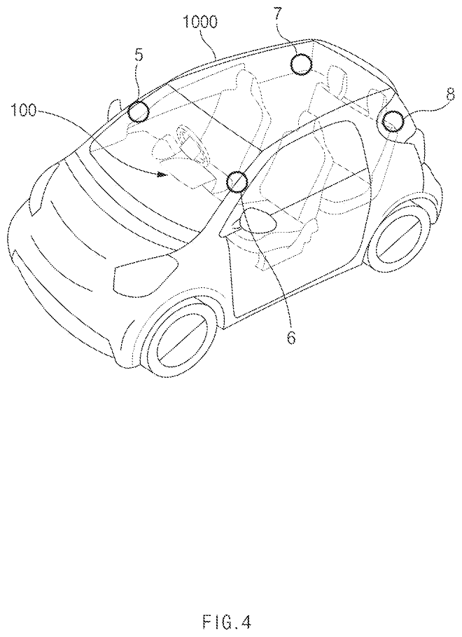

FIG. 4 is a view illustrating determination of the position of a user according to an embodiment.

Referring to FIG. 4, at least one beacon device 5, 6, 7, and/or 8 may be disposed in at least one area inside the vehicle 1000. For example, the beacon device 5, 6, 7, and/or 8 may be disposed on at least a part of the front pillars (e.g., the A pillars) or the rear pillars (e.g., the C pillars) of the vehicle 1000. In an embodiment, the at least one beacon device 5, 6, 7, and/or 8 may each transmit a specific signal based on Bluetooth Low Energy within a specified range (e.g., a range including the most adjacent seat). In this regard, a mobile device of at least one user in the vehicle 1000 may include an application program for receiving the specific signal. Accordingly, the at least one beacon device 5, 6, 7, and/or 8 may each determine a presence or absence of a mobile device that receives the specific signal within the specified range, and may thus determine whether the user is in the seat within the corresponding range. Based on access to the network (200 of FIG. 2) constructed by the at least one beacon device 5, 6, 7, and/or 8 together with the electronic device 100, the at least one beacon device 5, 6, 7, and/or 8 may each transmit information relating to the determining of whether the user is in the seat, to the electronic device 100.

In another embodiment, a sensor module (e.g., a pressure sensor, a proximity sensor, or the like) may be disposed in at least one area of a seat in the vehicle 1000. The sensor module may detect a weight change of a specified magnitude or more for the corresponding seat or a presence or absence of an object (e.g., a human body) within a specified distance from the corresponding seat and may provide the detection information to the electronic device 100. In another embodiment, a receiver (e.g., a near field communication receiver) may be disposed in at least one area of a seat in the vehicle 1000 and may perform radio frequency identification with a mobile device of a user in the corresponding seat. The receiver may provide the radio frequency identification information of the corresponding seat to the electronic device 100 and may support tracking the position of at least one user in the vehicle 1000. In another embodiment, at least one camera module may be included in at least one area of the display (130 of FIG. 2) that is disposed in the vehicle 1000. In real time or every specified period, the camera module may photograph the interior of the vehicle 1000 and may transmit photographing information to the electronic device 100. The processor (150 of FIG. 2) of the electronic device 100 may identify at least one user based on analysis (e.g., facial recognition) of an image (e.g., a still image, a video, or the like) that is received from the camera module, and may map the position of the user identified in the image and the positions of the seats in the vehicle 1000 to determine the position of the user.

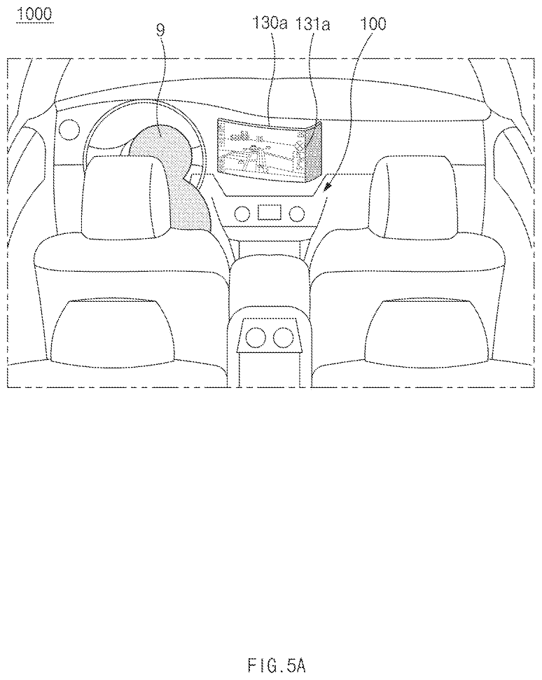

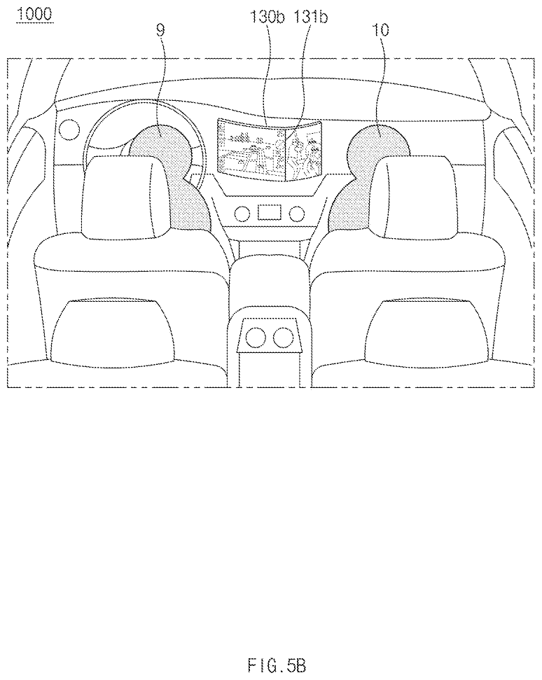

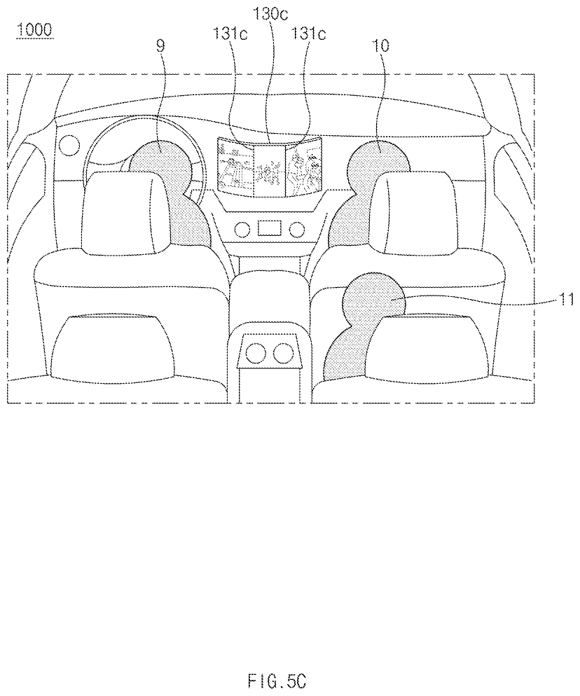

FIGS. 5A, 5B, and 5C are views illustrating various shapes of the display according to an embodiment.

Referring to FIG. 5A, a first user 9 (e.g., the driver) in the vehicle 1000 may control the playback of first contents by applying an input (e.g., a touch) to at least one area of a specific interface (e.g., the center fascia) that interacts with the electronic device 100. Alternatively, the first user 9 may control the playback of the first contents by applying an input to a specified menu displayed on at least one area of the display (130 of FIG. 2). In this operation, the processor (150 of FIG. 2) of the electronic device 100 may determine the property of the first contents (e.g., the type of the contents). In an embodiment, when the determined property of the first contents corresponds to contents (e.g., navigation contents) related to travel of the vehicle 1000, the processor 150 may control the actuator module (140 of FIG. 2) to deform the shape of at least one area of a display 130a. In this regard, the processor 150 may determine the position of the first user 9, based on information received from an external device (e.g., a beacon device, a sensor module, a radio frequency identification receiver, or the like) in the vehicle. The processor 150 may divide the screen area of the display 130a into a first virtual area and a second virtual area, based on the determined position of the first user 9. In an embodiment, when one user is in the vehicle 1000 as illustrated in FIG. 5A, the division of the first virtual area and the second virtual area by the processor 150 may be implemented at a specified ratio (e.g., 9:1, 8:2, or the like). The processor 150 may control the actuator module (140 of FIG. 2) to deform the shape of the display 130a such that a boundary 131a between the first virtual area and the second virtual area divided from each other is bent forward with respect to the display 130a.

Referring to FIG. 5B, the first user 9 and a second user 10 may sit on first-row seats (e.g., the driver's seat and the front passenger seat) in the vehicle 1000. According to an embodiment, the second user 10 may control the playback of second contents in the state in which the shape of the display is deformed according to the first-contents playback control of the first user 9 as described above with reference to FIG. 5A. Alternatively, the first user 9 and the second user 10 may control the playback of the first contents and the second contents at the same time or with a time difference within a specified time range. In various embodiments, the second contents may include contents stored in the memory (120 of FIG. 2) of the electronic device 100, or may include contents received or mirrored from a mobile device of the second user 10.

In an embodiment, the processor 150 may determine the importance of the first contents and the second contents, based on the properties of the first contents and the second contents (e.g., the types of the contents). For example, the processor 150 may determine the importance of the first contents and the second contents, depending on whether the first contents and the second contents are related to travel of the vehicle 1000 (e.g., whether the first contents and the second contents are navigation contents or not). Based on position information of the first user 9 and the second user 10, the processor 150 may divide the screen area of a display 130b into a first virtual area corresponding to the position of the first user 9 and a second virtual area corresponding to the position of the second user 10. In this operation, based on the determination of the importance of the first contents and the second contents, the processor 150 may determine the ratio at which the first virtual area and the second virtual area are divided from each other. For example, when the first contents controlled to be played by the first user 9 are contents related to travel of the vehicle 1000, the processor 150 may relatively increase the ratio of the first virtual area. Alternatively, the processor 150 may relatively increase the ratio of the second virtual area when the first contents controlled to be played by the first user 9 are irrelevant to travel of the vehicle 1000 and the second contents controlled to be played by the second user 10 are contents with a wide resolution. When the screen area of the display 130b is completely divided into the first virtual area and the second virtual area, the processor 150 may control the actuator module 140 to deform the shape of the display 130b such that a boundary 131b between the first virtual area and the second virtual area is bent forward with respect to the display 130b.

In various embodiments, based on the determination of the importance of the first contents and the second contents, the processor 150 may support only outputting sounds of specific contents with more importance (e.g., contents related to travel of the vehicle 1000). In an embodiment, when only the second user 10 other than the first user 9 performs contents playback control, shape deformation of the display 130b may be controlled by a method similar to that described above with reference to FIG. 5A.

Referring to FIG. 5C, the first user 9 and the second user 10 may sit on the first-row seats (e.g., the driver's seat and the front passenger seat) in the vehicle 1000, and at least one third user 11 may sit on a second-row seat (e.g., a rear seat). In various embodiments, the at least one third user 11 may sit on a seat behind any one of the first user 9 or the second user 10, or may sit on a seat behind each of the first user 9 and the second user 10.

According to an embodiment, the second user 10 and the third user 11 may control the playback of second contents and third contents in the state in which the shape of a display 130c is deformed according to first-contents playback control of the first user 9. Alternatively, the first user 9, the second user 10, and the third user 11 may control the playback of the first contents, the second contents, and the third contents at the same time or with a time difference within a specified time range. Based on position information of the users 9, 10, and 11, the processor 150 may divide the screen area of the display 130c into a first virtual area corresponding to the first user 9, a second virtual area corresponding to the second user 10, and a third virtual area corresponding to the third user 11. Similarly to that described above with reference to FIG. 5B, the ratio at which the first virtual area, the second virtual area, and the third virtual area are divided from each other may be determined based on determination of the importance of the first contents, the second contents, and the third contents by the processor 150. For example, when the first contents controlled to be played by the first user 9 (e.g., the driver) are contents (e.g., navigation contents) related to travel of the vehicle 1000, the ratio of the first virtual area corresponding to the first user 9 may be relatively increased. Alternatively, when the first contents are irrelevant to travel of the vehicle 1000, the ratio at which the first virtual area, the second virtual area, and the third virtual area are divided from each other may be determined depending on the properties of the contents corresponding to the respective areas (e.g., the types of the contents, the resolutions of the contents, or the like). When the screen area of the display 130c is completely divided into the first virtual area, the second virtual area, and the third virtual area, the processor 150 may control the actuator module 140 to deform the shape of the display 130c such that at least one boundary 131c between the first virtual area, the second virtual area, and the third virtual area is bent forward with respect to the display 130c.

According to an embodiment, the deformed display (130a of FIG. 5A, 130b of FIG. 5B, or 130c of FIG. 5C) may be returned to the initial shape before the deformation, according to the driving state of the vehicle 1000. For example, when the first user 9 sets the driving method of the vehicle 1000 to autonomous driving based on system control during travel of the vehicle 1000, the processor 150 may control the actuator module 140 to return the deformed display 130a, 130b, or 130c to the initial shape. Alternatively, when specified time elapses after the vehicle 1000 stops, or the vehicle (1000) system is switched into a parking state, the processor 150 may return the deformed display 130a, 130b, or 130c to the initial shape. In the case where the driving method of the vehicle 1000 is set to autonomous driving at the time when at least one user controls the playback of at least one piece of content, the processor 150 may exclude shape deformation control of the display 130a, 130b, or 130c and may maintain the initial shape.

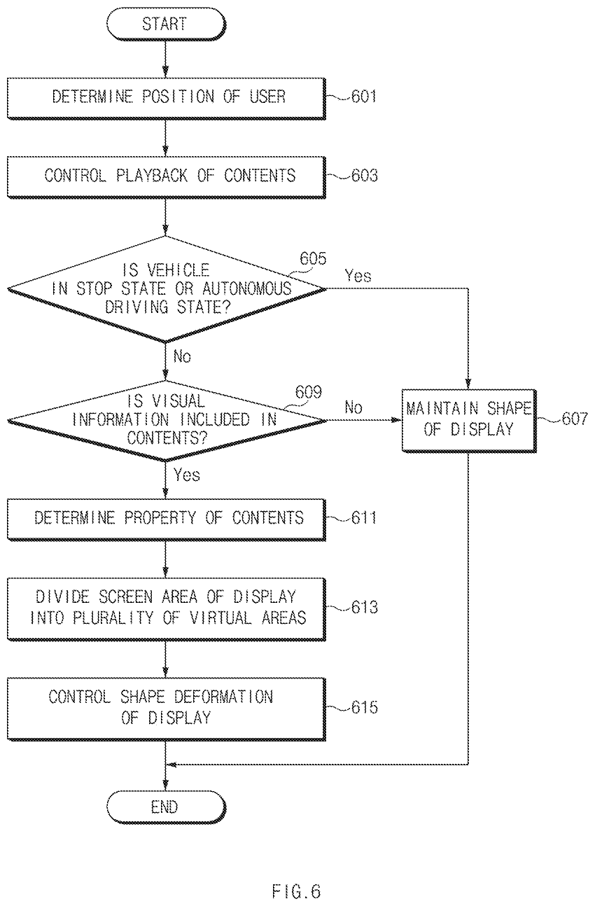

FIG. 6 is a view illustrating a series of processes for shape deformation of the display according to an embodiment.

Referring to FIG. 6, in operation 601, the processor (150 of FIG. 2) of the electronic device (100 of FIG. 2) may determine the position of at least one user in the vehicle, based on information received from at least one external device (e.g., a beacon device, a sensor module, a radio frequency identification receiver, or the like) that is disposed inside the vehicle (1000 of FIG. 1).

In operation 603, the at least one user in the vehicle may control the playback of at least one piece of content. For example, the at least one user may control the playback of the at least one piece of content by applying an input (e.g., a touch) to a specific interface (e.g., the center fascia) in the vehicle that interacts with the electronic device, or the display (130 of FIG. 2) of the electronic device. In an embodiment, the at least one piece of content may include contents stored in the memory (120 of FIG. 2) of the electronic device, or may include contents received or mirrored from a mobile device of the at least one user.

In operation 605, the processor may determine the driving state of the vehicle through an interaction with a vehicle system. For example, in real time or every specified period, the processor may determine whether the vehicle travels or stops, or may determine whether the vehicle is manually driven by the user (e.g., the driver) or travels autonomously. In an embodiment, when the determined state of the vehicle corresponds to a state in which the vehicle is stopped (or parked) for a specified period of time or more, or a state in which the vehicle is configured to travel autonomously, the processor may, in operation 607, exclude shape deformation control of the display.

In an embodiment, when the vehicle is manually driven by a specific user (e.g., the driver), the processor may, in operation 609, determine whether the at least one piece of content controlled to be played by the at least one user includes visual information. If it is determined that no visual information is included in the at least one piece of content, the processor may exclude shape deformation control for the display as in operation 607 described above.

In an embodiment, when it is determined that visual information is included in the at least one piece of content controlled to be played by the at least one user, the processor may, in operation 611, determine the property of the at least one piece of content. For example, the processor may determine the type of the content, the resolution of the content, or the like. Furthermore, the processor may determine the importance of the at least one piece of content, based on the determination of the property of the at least one piece of content. For example, the processor may determine the importance of the at least one piece of content, depending on whether the at least one piece of content is related to travel of the vehicle (e.g., whether the at least one piece of content corresponds to navigation contents or not).

In operation 613, the processor may divide the screen area of the display into a plurality of virtual areas. In this operation, based on the determination of the importance of the at least one piece of content, the processor may determine the ratio at which the plurality of virtual areas are divided from each other. For example, when contents (e.g., navigation contents) related to travel of the vehicle are present in the at least one piece of content controlled to be played by the at least one user, the processor may relatively increase the ratio of the virtual area that corresponds to the position of the user that controls the playback of the corresponding content. Alternatively, when the at least one piece of content controlled to be played by the at least one user is irrelevant to travel of the vehicle, the processor may identify the resolution of the at least one piece of content. The processor may identify contents with a wide resolution among the at least one piece of content and may relatively increase the ratio of the virtual area that corresponds to the position of the user that controls the playback of the identified contents with the wide resolution.

In operation 615, the processor may control the actuator module (140 of FIG. 2) to deform the shape of the display such that boundaries between the plurality of virtual areas divided from each other are bent forward with respect to the display. In various embodiments, after the shape deformation of the display, the processor may further determine the above-described driving state of the vehicle in real time or every specified period. The processor may return the deformed display to the initial shape when it is determined that the state of the vehicle corresponds to a state in which the vehicle is stopped (or parked) for a specified period of time or more or a state in which the vehicle is configured to travel autonomously.

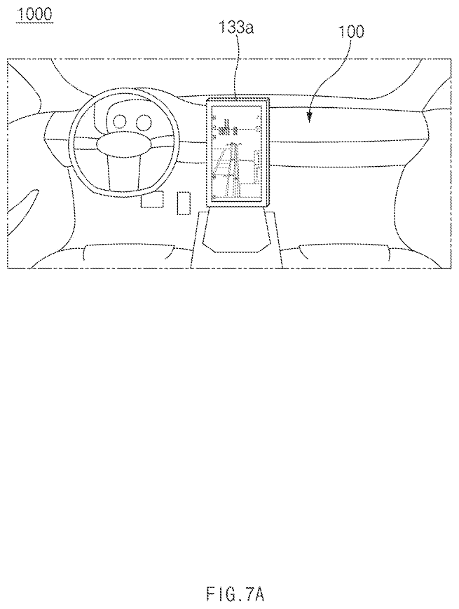

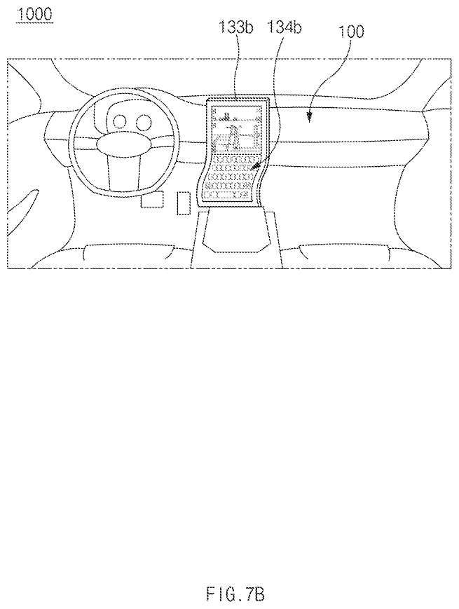

FIGS. 7A and 7B are views illustrating various shapes of the display according to another embodiment. The shapes of the display illustrated in FIGS. 7A and 7B are merely illustrative, and the display is not limited to those illustrated. The display may include various shapes as long as shape deformation of the display that will be described below is able to be implemented.

Referring to FIG. 7A, the display (130 of FIG. 2) of the electronic device 100 according to another embodiment that is mounted in the vehicle 1000 may include a portrait display 133a that is longer in a first direction (e.g., the vertical direction) than in a second direction (e.g., the horizontal direction). The processor (150 of FIG. 2) of the electronic device 100 may deform the shape of the display 133a according to the screen configuration of contents displayed on the display 133a. For example, when a control interface (e.g., a software input panel (SIP) keyboard) is output on the contents in response to scheduling information set for the contents (or, a user input (e.g., a touch) that is applied to the contents) in the operation of playing or displaying the contents, the processor 150 may deform the shape of the area of the display 133a that corresponds to the control interface.

Referring to FIG. 7B with regard to the above description, when a control interface 134b is displayed or output on the contents, the processor 150 may determine the area or the coordinates where the control interface 134b is located on the screen area of a display 133b, based on data analysis of the contents. The processor 150 may control the actuator module 140 based on the determined position or coordinates of the control interface 134b to deform the shape of the area of the display 133b that corresponds to the control interface 134b. For example, the processor 150 may deform the shape of the display 133b to form a predetermined slope or angle between a first area corresponding to the control interface 134b and a second area other than the first area on the screen area of the display 133b. The shape deformation of the display 133b may provide easy access of a user to the control interface 134b or convenience of a user input (e.g., a touch).

In various embodiments, the processor 150 may deform the shape of the display 133b, on which the control interface 134b is output, according to the position of a user (or, an occupant) in the vehicle 1000. For example, when a first user (e.g., the driver) is in the vehicle 1000, the processor 150 may deform the shape of the display 133b to cause the control interface 134b to face the direction corresponding to the position of the first user (e.g., the driver). Alternatively, when the first user (e.g., the driver) and a second user (e.g., a passenger) are in the vehicle 1000, the processor 150 may deform the shape of the display 133b to cause the control interface 134b to correspond to the position of the second user. In this case, an environment in which the second user is responsible for input control of the control interface 134b and the first user focuses his/her attention on driving of the vehicle 1000 may be created.

In various embodiments, when the first user (e.g., the driver) and the second user (e.g., a passenger) are in the vehicle 1000, the processor 150 may restrict the first user from operating the control interface 134b or may allow for only part of the operation. For example, the processor 150 may determine the property (e.g., the type) of the contents including the control interface 134b, and when the contents are irrelevant to travel of the vehicle 1000, the processor 150 may exclude receipt of a signal for an input of the first user that is applied to the control interface 134b, or may receive only part of the signal (e.g., a volume control signal for the contents). In this regard, a sensor module (e.g., a proximity sensor or the like) may be included in at least one area of the display 133a or 133b. The sensor module may detect the direction in which a user's body (e.g., hand) accesses, and, for example, when access from the driver's seat (or, the position of the first user) is detected, the sensor module may provide the detection information to the processor 150. Alternatively, the processor 150 may restrict a user (e.g., the first user) from operating the control interface 134b, or may allow for only part of the operation, according to the driving state of the vehicle 1000. For example, the processor 150 may identify the driving state of the vehicle 1000 in real time or every specified period, and when the vehicle 1000 travels at a specified critical speed or more or is manually driven by a user, the processor 150 may at least partly restrict the user from operating the control interface 134b.

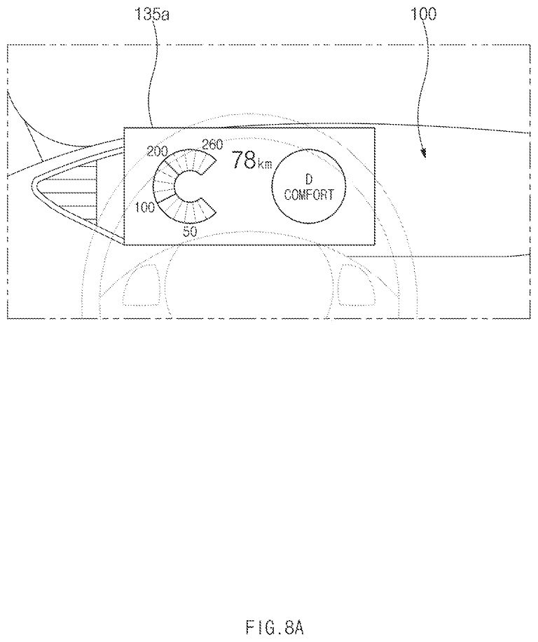

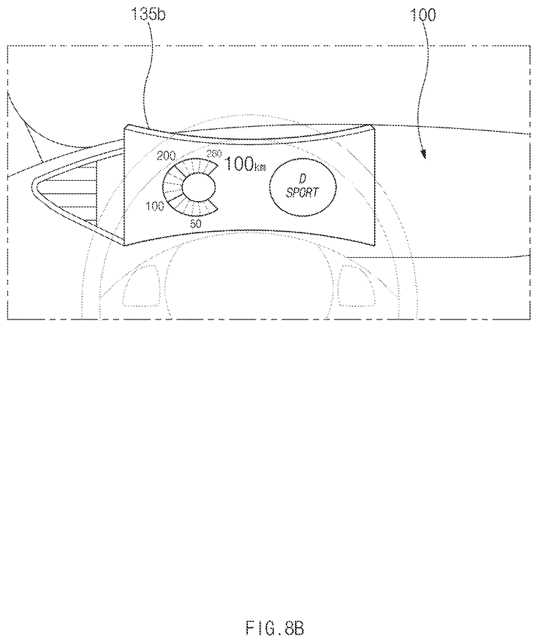

FIGS. 8A and 8B are views illustrating various shapes of the display according to yet another embodiment.

Referring to FIG. 8A, the display (130 of FIG. 2) of the electronic device 100 according to yet another embodiment may include a display 135a that implements a cluster in the vehicle 1000. The processor (150 of FIG. 2) of the electronic device 100 may control shape deformation of the display 135a according to the driving method (e.g., comfort or sport) of the vehicle 1000 or the travel speed thereof. In this regard, the processor 150 may obtain information regarding the driving method or the travel speed of the vehicle 1000 from the vehicle (1000) system in real time or every specified period. When the driving method of the vehicle 1000 is normal driving (e.g., comfort) or the travel speed of the vehicle 1000 is lower than a specified critical speed, the processor 150 may maintain the display 135a in a flat shape that is the initial shape.

Referring to FIGS. 8A and 8B with regard to the above description, when the driving method of the vehicle 1000 is changed from the normal driving to high-speed driving (e.g., sport), the processor 150 may deform the shape of the display 135a with regard to an improvement in the readability or immersion of a user for various types of information displayed on the cluster. Alternatively, when the travel speed of the vehicle 1000 exceeds the specified critical speed, the processor 150 may deform the shape of the display 135a. For example, the processor 150 may control the actuator module (140 of FIG. 2) to cause opposite longitudinal end areas of the display 135a to protrude forward with respect to the display 135a. In this case, the display 135a in the flat shape may be deformed into a display 135b having a shape in which central areas are recessed to a specified size.

An electronic device included in at least one area inside a vehicle may include a display having at least one area including a flexible characteristic, a memory that stores at least one application program, an actuator module that supports shape deformation of the at least one area of the display, and a processor electrically connected to the display, the memory, and the actuator module.

According to various embodiments, the processor may determine a position of at least one user in the vehicle and may perform control to deform the at least one area of the display in a direction corresponding to the position of the user, when a specified requirement is satisfied with regard to the shape deformation of the at least one area of the display.

According to various embodiments, the processor may control the shape deformation of the at least one area of the display when a first requirement that at least one piece of content is controlled to be played on the display by the at least one user, a second requirement that the at least one piece of content controlled to be played includes visual information, and a third requirement that manual driving is performed by the at least one user with regard to travel of the vehicle are satisfied.

According to various embodiments, the processor may perform control to return the deformed display to a shape before the shape deformation, when autonomous driving is set by the at least one user with regard to travel of the vehicle after the at least one area of the display is deformed.

According to various embodiments, the processor may determine a property of contents controlled to be played by a first user, when the first user relevant to travel of the vehicle is in the vehicle, and the processor may perform control to deform the at least one area of the display in a direction corresponding to a position of the first user, when the property of the contents is related to the travel of the vehicle.

According to various embodiments, the processor may perform control to divide a screen area of the display into a first virtual area and a second virtual area.

According to various embodiments, the processor may control the division of the first virtual area and the second virtual area to cause the first virtual area corresponding to the position of the first user to be larger in size than the second virtual area.

According to various embodiments, the processor may control the actuator module to deform a boundary between the first virtual area and the second virtual area into a specified shape.

According to various embodiments, the processor may determine properties of contents controlled to be played by a plurality of second users and may perform control to divide a screen area of the display into a plurality of virtual areas, based on the determination of the properties, when the plurality of second users are in the vehicle.

According to various embodiments, the processor may control the division of the plurality of virtual areas to cause a virtual area corresponding to first contents to be larger in size than virtual areas corresponding to the other contents, when the first contents related to travel of the vehicle are included in the contents controlled to be played by the plurality of second users.

According to various embodiments, the processor may control the division of the plurality of virtual areas to cause a virtual area corresponding to first contents to be larger in size than virtual areas corresponding to the other contents, when the contents controlled to be played by the plurality of second users are irrelevant to travel of the vehicle and include the first contents related to a specified resolution.

According to various embodiments, the processor may determine properties of contents controlled to be played by a plurality of second users and may perform control to output a sound for specific contents, based on the determination of the properties, when the plurality of second users are in the vehicle.

According to various embodiments, the processor may perform control to deform at least one area of the display corresponding to a control interface in a direction corresponding to a position of a first user, when the first user relevant to travel of the vehicle is in the vehicle and the control interface is displayed on the display.

According to various embodiments, the processor may control the shape deformation of the at least one area of the display to cause a first area of the display corresponding to a control interface to form a specified slope with a second area other than the first area, when the control interface is displayed on the display.

According to various embodiments, the processor may perform control to deform at least one area of the display corresponding to a control interface in a direction corresponding to a position of a user that is irrelevant to travel of the vehicle among a plurality of second users, when the plurality of second users are in the vehicle and the control interface is displayed on the display.

According to various embodiments, the electronic device may further include a sensor module disposed in the at least one area of the display.

According to various embodiments, the processor may exclude receipt of at least some signals for a user input applied to a control interface, according to a direction of the user's access to the display that is detected based on the sensor module, when the control interface is displayed on the display.

According to various embodiments, the processor may exclude receipt of at least some signals for a user input applied to a control interface, when the vehicle travels at a specified critical speed or more or is manually driven by the at least one user in the case where the control interface is displayed on the display.

A vehicle may include an electronic device in at least one area thereof, and the electronic device may include a display having at least one area including a flexible characteristic, a memory that stores at least one application program, an actuator module that supports shape deformation of the at least one area of the display, and a processor electrically connected to the display, the memory, and the actuator module. The processor may determine a position of at least one user in the vehicle and may perform control to deform the at least one area of the display in a direction corresponding to the position of the user, when a specified requirement is satisfied with regard to the shape deformation of the at least one area of the display.

FIG. 9 is a view illustrating an electronic device in a network environment according to an embodiment.

An electronic device 901 in a network environment 900 according to various embodiments of the present disclosure will be described with reference to FIG. 9. The electronic device 901 may include a bus 910, a processor 920, a memory 930, an input/output interface 950, a display 960, and a communication interface 970. In various embodiments of the present disclosure, at least one of the foregoing elements may be omitted or another element may be added to the electronic device 901.

The bus 910 may include a circuit for connecting the above-mentioned elements 910 to 970 to each other and transferring communications (e.g., control messages and/or data) among the above-mentioned elements.

The processor 920 may include at least one of a central processing unit (CPU), an application processor (AP), or a communication processor (CP). The processor 920 may perform data processing or an operation related to communication and/or control of at least one of the other elements of the electronic device 901.

The memory 930 may include a volatile memory and/or a nonvolatile memory. The memory 930 may store instructions or data related to at least one of the other elements of the electronic device 901. According to an embodiment of the present disclosure, the memory 930 may store software and/or a program 940. The program 940 may include, for example, a kernel 941, a middleware 943, an application programming interface (API) 945, and/or an application program (or an application) 947. At least a portion of the kernel 941, the middleware 943, or the API 945 may be referred to as an operating system (OS).

The kernel 941 may control or manage system resources (e.g., the bus 910, the processor 920, the memory 930, or the like) used to perform operations or functions of other programs (e.g., the middleware 943, the API 945, or the application program 947). Furthermore, the kernel 941 may provide an interface for allowing the middleware 943, the API 945, or the application program 947 to access individual elements of the electronic device 901 in order to control or manage the system resources.

The middleware 943 may serve as an intermediary so that the API 945 or the application program 947 communicates and exchanges data with the kernel 941.

Furthermore, the middleware 943 may handle one or more task requests received from the application program 947 according to a priority order. For example, the middleware 943 may assign at least one application program 947 a priority for using the system resources (e.g., the bus 910, the processor 920, the memory 930, or the like) of the electronic device 901. For example, the middleware 943 may handle the one or more task requests according to the priority assigned to the at least one application, thereby performing scheduling or load balancing with respect to the one or more task requests.

The API 945, which is an interface for allowing the application 947 to control a function provided by the kernel 941 or the middleware 943, may include, for example, at least one interface or function (e.g., instructions) for file control, window control, image processing, character control, or the like.

The input/output interface 950 may serve to transfer an instruction or data input from a user or another external device to (an)other element(s) of the electronic device 901. Furthermore, the input/output interface 950 may output instructions or data received from (an)other element(s) of the electronic device 901 to the user or another external device.

The display 960 may include, for example, a liquid crystal display (LCD), a light-emitting diode (LED) display, an organic light-emitting diode (OLED) display, a microelectromechanical systems (MEMS) display, or an electronic paper display. The display 960 may present various content (e.g., a text, an image, a video, an icon, a symbol, or the like) to the user. The display 960 may include a touch screen, and may receive a touch, gesture, proximity or hovering input from an electronic pen or a part of a body of the user.

The communication interface 970 may set communications between the electronic device 901 and an external device (e.g., a first external electronic device 902, a second external electronic device 904, or a server 906). For example, the communication interface 970 may be connected to a network 962 via wireless communications or wired communications so as to communicate with the external device (e.g., the second external electronic device 904 or the server 906).

The wireless communications may employ at least one of cellular communication protocols such as long-term evolution (LTE), LTE-advance (LTE-A), code division multiple access (CDMA), wideband CDMA (WCDMA), universal mobile telecommunications system (UMTS), wireless broadband (WiBro), or global system for mobile communications (GSM). The wireless communications may include, for example, a short-range communications 964. The short-range communications may include at least one of wireless fidelity (Wi-Fi), Bluetooth, near field communication (NFC), magnetic stripe transmission (MST), or GNSS.

The MST may generate pulses according to transmission data and the pulses may generate electromagnetic signals. The electronic device 901 may transmit the electromagnetic signals to a reader device such as a POS (point of sales) device. The POS device may detect the electromagnetic signals by using a MST reader and restore data by converting the detected electromagnetic signals into electrical signals.

The GNSS may include, for example, at least one of global positioning system (GPS), global navigation satellite system (GLONASS), BeiDou navigation satellite system (BeiDou), or Galileo, the European global satellite-based navigation system according to a use area or a bandwidth. Hereinafter, the term “GPS” and the term “GNSS” may be interchangeably used. The wired communications may include at least one of universal serial bus (USB), high definition multimedia interface (HDMI), recommended standard 232 (RS-232), plain old telephone service (POTS), or the like. The network 962 may include at least one of telecommunications networks, for example, a computer network (e.g., local area network (LAN) or wide area network (WAN)), the Internet, or a telephone network.

The types of the first external electronic device 902 and the second external electronic device 904 may be the same as or different from the type of the electronic device 901. According to an embodiment of the present disclosure, the server 906 may include a group of one or more servers. A portion or all of operations performed in the electronic device 901 may be performed in one or more other electronic devices (e.g., the first electronic device 902, the second external electronic device 904, or the server 906). When the electronic device 901 should perform a certain function or service automatically or in response to a request, the electronic device 901 may request at least a portion of functions related to the function or service from another device (e.g., the first electronic device 902, the second external electronic device 904, or the server 906) instead of or in addition to performing the function or service for itself. The other electronic device (e.g., the first electronic device 902, the second external electronic device 904, or the server 906) may perform the requested function or additional function, and may transfer a result of the performance to the electronic device 901. The electronic device 901 may use a received result itself or additionally process the received result to provide the requested function or service. To this end, for example, a cloud computing technology, a distributed computing technology, or a client-server computing technology may be used.

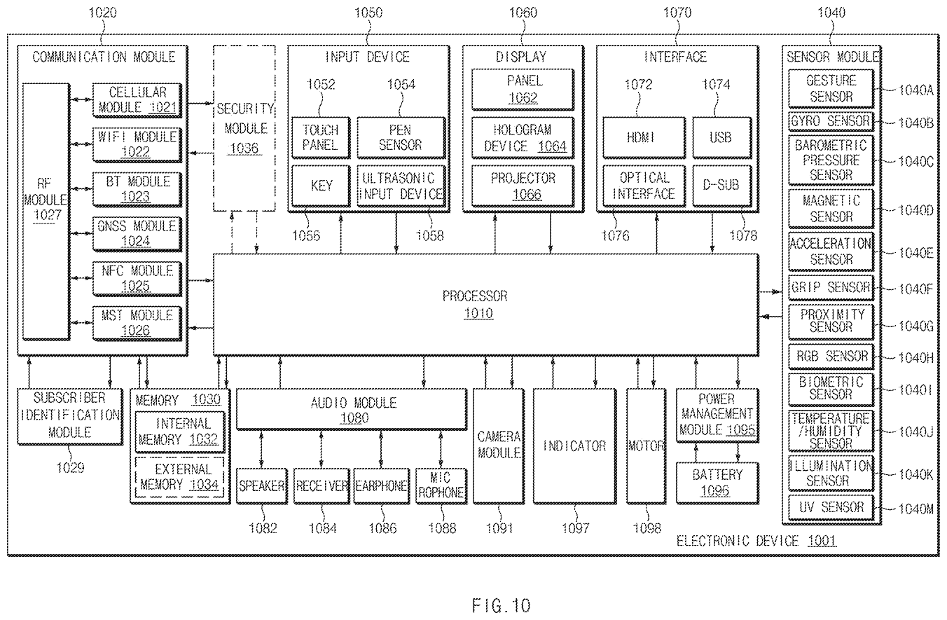

FIG. 10 is a view illustrating a block diagram of an electronic device according to an embodiment.

Referring to FIG. 10, the electronic device 1001 may include, for example, all or part of an electronic device 901 shown in FIG. 9. The electronic device 1001 may include one or more processors 1010 (e.g., application processors (APs)), a communication module 1020, a subscriber identification module (SIM) 1029, a memory 1030, a security module 1036, a sensor module 1040, an input device 1050, a display 1060, an interface 1070, an audio module 1080, a camera module 1091, a power management module 1095, a battery 1096, an indicator 1097, and a motor 1098.

The processor 1010 may drive, for example, an operating system (OS) or an application program to control a plurality of hardware or software components connected thereto and may process and compute a variety of data. The processor 1010 may be implemented with, for example, a system on chip (SoC). According to an embodiment of the present disclosure, the processor 1010 may include a graphic processing unit (GPU) (not shown) and/or an image signal processor (not shown). The processor 1010 may include at least some (e.g., a cellular module 1021) of the components shown in FIG. 10. The processor 1010 may load a command or data received from at least one of other components (e.g., a non-volatile memory) into a volatile memory to process the data and may store various data in a non-volatile memory.

The communication module 1020 may have the same or similar configuration to the communication interface 970 of FIG. 9. The communication module 1020 may include, for example, the cellular module 1021, a wireless-fidelity (Wi-Fi) module 1022, a Bluetooth (BT) module 1023, a global navigation satellite system (GNSS) module 1024 (e.g., a GPS module, a Glonass module, a Beidou module, or a Galileo module), a near field communication (NFC) module 1025, an MST module 1026, and a radio frequency (RF) module 1027.

The cellular module 1021 may provide, for example, a voice call service, a video call service, a text message service, or an Internet service, and the like through a communication network. According to an embodiment of the present disclosure, the cellular module 1021 may identify and authenticate the electronic device 1001 in a communication network using the SIM 1029 (e.g., a SIM card). According to an embodiment of the present disclosure, the cellular module 1021 may perform at least part of functions which may be provided by the processor 1010. According to an embodiment of the present disclosure, the cellular module 1021 may include a communication processor (CP).

The Wi-Fi module 1022, the BT module 1023, the GNSS module 1024, the NFC module 1025, or the MST module 1026 may include, for example, a processor for processing data transmitted and received through the corresponding module. According to various embodiments of the present disclosure, at least some (e.g., two or more) of the cellular module 1021, the Wi-Fi module 1022, the BT module 1023, the GNSS module 1024, the NFC module 1025, or the MST module 1026 may be included in one integrated chip (IC) or one IC package.

The RF module 1027 may transmit and receive, for example, a communication signal (e.g., an RF signal). Though not shown, the RF module 1027 may include, for example, a transceiver, a power amplifier module (PAM), a frequency filter, or a low noise amplifier (LNA), or an antenna, and the like. According to another embodiment of the present disclosure, at least one of the cellular module 1021, the Wi-Fi module 1022, the BT module 1023, the GNSS module 1024, the NFC module 1025, or the MST module 1026 may transmit and receive an RF signal through a separate RF module.

The SIM 1029 may include, for example, a card which includes a SIM and/or an embedded SIM. The SIM 1029 may include unique identification information (e.g., an integrated circuit card identifier (ICCID)) or subscriber information (e.g., an international mobile subscriber identity (IMSI)).

The memory 1030 (e.g., a memory 930 of FIG. 9) may include, for example, an embedded memory 1032 or an external memory 1034. The embedded memory 1032 may include at least one of, for example, a volatile memory (e.g., a dynamic random access memory (DRAM), a static RAM (SRAM), a synchronous dynamic RAM (SDRAM), and the like), or a non-volatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory or a NOR flash memory, and the like), a hard drive, or a solid state drive (SSD)).

The external memory 1034 may include a flash drive, for example, a compact flash (CF), a secure digital (SD), a micro-SD, a mini-SD, an extreme digital (xD), a multimedia card (MMC), or a memory stick, and the like. The external memory 1034 may operatively and/or physically connect with the electronic device 1001 through various interfaces.

The security module 1036 may be a module which has a relatively higher secure level than the memory 1030 and may be a circuit which stores secure data and guarantees a protected execution environment. The security module 1036 may be implemented with a separate circuit and may include a separate processor. The security module 1036 may include, for example, an embedded secure element (eSE) which is present in a removable smart chip or a removable SD card or is embedded in a fixed chip of the electronic device 1001. Also, the security module 1036 may be driven by an OS different from the OS of the electronic device 1001. For example, the security module 1036 may operate based on a java card open platform (JCOP) OS.

The sensor module 1040 may measure, for example, a physical quantity or may detect an operation state of the electronic device 1001, and may convert the measured or detected information to an electric signal. The sensor module 1040 may include at least one of, for example, a gesture sensor 1040A, a gyro sensor 1040B, a barometric pressure sensor 1040C, a magnetic sensor 1040D, an acceleration sensor 1040E, a grip sensor 1040F, a proximity sensor 1040G, a color sensor 1040H (e.g., red, green, blue (RGB) sensor), a biometric sensor 1040I, a temperature/humidity sensor 1040J, an illumination sensor 1040K, or an ultraviolet (UV) sensor 1040M. Additionally or alternatively, the sensor module 1040 may further include, for example, an e-nose sensor (not shown), an electromyography (EMG) sensor (not shown), an electroencephalogram (EEG) sensor (not shown), an electrocardiogram (ECG) sensor (not shown), an infrared (IR) sensor (not shown), an iris sensor (not shown), and/or a fingerprint sensor (not shown), and the like. The sensor module 1040 may further include a control circuit for controlling at least one or more sensors included therein. According to various embodiments of the present disclosure, the electronic device 1001 may further include a processor configured to control the sensor module 1040, as part of the processor 1010 or to be independent of the processor 1010. While the processor 1010 is in a sleep state, the electronic device 1001 may control the sensor module 1040.

The input device 1050 may include, for example, a touch panel 1052, a (digital) pen sensor 1054, a key 1056, or an ultrasonic input device 1058. The touch panel 1052 may use at least one of, for example, a capacitive type, a resistive type, an infrared type, or an ultrasonic type. Also, the touch panel 1052 may further include a control circuit. The touch panel 1052 may further include a tactile layer and may provide a tactile reaction to a user.

The (digital) pen sensor 1054 may be, for example, part of the touch panel 1052 or may include a separate sheet for recognition. The key 1056 may include, for example, a physical button, an optical key, or a keypad. The ultrasonic input device 1058 may allow the electronic device 1001 to detect a sound wave using a microphone (e.g., a microphone 1088) and to verify data through an input tool generating an ultrasonic signal.

The display 1060 (e.g., a display 960 of FIG. 9) may include a panel 1062, a hologram device 1064, or a projector 1066. The panel 1062 may include the same or similar configuration to the display 1060. The panel 1062 may be implemented to be, for example, flexible, transparent, or wearable. The panel 1062 and the touch panel 1052 may be integrated into one module. The hologram device 1064 may show a stereoscopic image in a space using interference of light. The projector 1066 may project light onto a screen to display an image. The screen may be positioned, for example, inside or outside the electronic device 1001. According to an embodiment of the present disclosure, the display 1060 may further include a control circuit for controlling the panel 1062, the hologram device 1064, or the projector 1066.

The interface 1070 may include, for example, a high-definition multimedia interface (HDMI) 1072, a universal serial bus (USB) 1074, an optical interface 1076, or a D-subminiature 1078. The interface 1070 may be included in, for example, the communication interface 970 shown in FIG. 9. Additionally or alternatively, the interface 1070 may include, for example, a mobile high definition link (MHL) interface, an SD card/multimedia card (MMC) interface, or an infrared data association (IrDA) standard interface.

The audio module 1080 may convert a sound and an electric signal in dual directions. At least part of components of the audio module 1080 may be included in, for example, an input and output interface 950 (or a user interface) shown in FIG. 9. The audio module 1080 may process sound information input or output through, for example, a speaker 1082, a receiver 1084, an earphone 1086, or the microphone 1088, and the like.

The camera module 1091 may be a device which captures a still image and a moving image. According to an embodiment of the present disclosure, the camera module 1091 may include one or more image sensors (not shown) (e.g., a front sensor or a rear sensor), a lens (not shown), an image signal processor (ISP) (not shown), or a flash (not shown) (e.g., an LED or a xenon lamp).

The power management module 1095 may manage, for example, power of the electronic device 1001. According to an embodiment of the present disclosure, though not shown, the power management module 1095 may include a power management integrated circuit (PMIC), a charger IC or a battery or fuel gauge. The PMIC may have a wired charging method and/or a wireless charging method. The wireless charging method may include, for example, a magnetic resonance method, a magnetic induction method, or an electromagnetic method, and the like. An additional circuit for wireless charging, for example, a coil loop, a resonance circuit, or a rectifier, and the like may be further provided. The battery gauge may measure, for example, the remaining capacity of the battery 1096 and voltage, current, or temperature thereof while the battery 1096 is charged. The battery 1096 may include, for example, a rechargeable battery or a solar battery.

The indicator 1097 may display a specific state of the electronic device 1001 or part (e.g., the processor 1010) thereof, for example, a booting state, a message state, or a charging state, and the like. The motor 1098 may convert an electric signal into mechanical vibration and may generate vibration or a haptic effect, and the like. Though not shown, the electronic device 1001 may include a processing unit (e.g., a GPU) for supporting a mobile TV. The processing unit for supporting the mobile TV may process media data according to standards, for example, a digital multimedia broadcasting (DMB) standard, a digital video broadcasting (DVB) standard, or a MediaFLO™ standard, and the like.

Each of the above-mentioned elements of the electronic device according to various embodiments of the present disclosure may be configured with one or more components, and names of the corresponding elements may be changed according to the type of the electronic device. The electronic device according to various embodiments of the present disclosure may include at least one of the above-mentioned elements, some elements may be omitted from the electronic device, or other additional elements may be further included in the electronic device. Also, some of the elements of the electronic device according to various embodiments of the present disclosure may be combined with each other to form one entity, thereby making it possible to perform the functions of the corresponding elements in the same manner as before the combination.

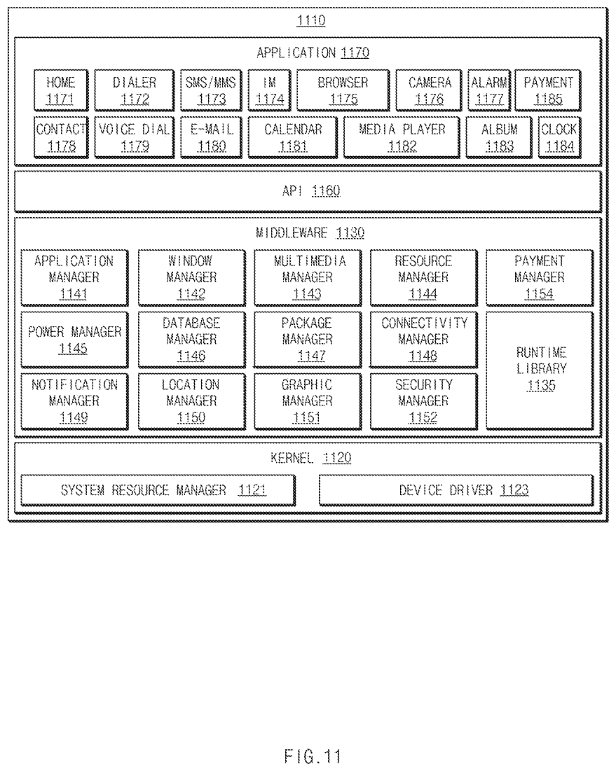

FIG. 11 is a view illustrating a block diagram of a program module according to an embodiment.

According to an embodiment of the present disclosure, the program module 1110 (e.g., a program 940 of FIG. 9) may include an operating system (OS) for controlling resources associated with an electronic device (e.g., an electronic device 901 of FIG. 9) and/or various applications (e.g., an application program 947 of FIG. 9) which are executed on the OS. The OS may be, for example, Android, iOS, Windows, Symbian, Tizen, or Bada, and the like.

The program module 1110 may include a kernel 1120, a middleware 1130, an application programming interface (API) 1160, and/or an application 1170. At least part of the program module 1110 may be preloaded on the electronic device, or may be downloaded from an external electronic device (e.g., a first external electronic device 902, a second external electronic device 904, or a server 906, and the like of FIG. 9).

The kernel 1120 (e.g., a kernel 941 of FIG. 9) may include, for example, a system resource manager 1121 and/or a device driver 1123. The system resource manager 1121 may control, assign, or collect, and the like system resources. According to an embodiment of the present disclosure, the system resource manager 1121 may include a process management unit, a memory management unit, or a file system management unit, and the like. The device driver 1123 may include, for example, a display driver, a camera driver, a Bluetooth (BT) driver, a shared memory driver, a universal serial bus (USB) driver, a keypad driver, a wireless-fidelity (Wi-Fi) driver, an audio driver, or an inter-process communication (IPC) driver.

The middleware 1130 (e.g., a middleware 943 of FIG. 9) may provide, for example, functions the application 1170 needs in common, and may provide various functions to the application 1170 through the API 1160 such that the application 1170 efficiently uses limited system resources in the electronic device. According to an embodiment of the present disclosure, the middleware 1130 (e.g., the middleware 943) may include at least one of a runtime library 1135, an application manager 1141, a window manager 1142, a multimedia manager 1143, a resource manager 1144, a power manager 1145, a database manager 1146, a package manager 1147, a connectivity manager 1148, a notification manager 1149, a location manager 1150, a graphic manager 1151, a security manager 1152, or a payment manager 1154.

The runtime library 1135 may include, for example, a library module used by a compiler to add a new function through a programming language while the application 1170 is executed. The runtime library 1135 may perform a function about input and output management, memory management, or an arithmetic function.

The application manager 1141 may manage, for example, a life cycle of at least one of the application 1170. The window manager 1142 may manage graphic user interface (GUI) resources used on a screen of the electronic device. The multimedia manager 1143 may determine a format utilized for reproducing various media files and may encode or decode a media file using a codec corresponding to the corresponding format. The resource manager 1144 may manage source codes of at least one of the application 1170, and may manage resources of a memory or a storage space, and the like.

The power manager 1145 may act together with, for example, a basic input/output system (BIOS) and the like, may manage a battery or a power source, and may provide power information utilized for an operation of the electronic device. The database manager 1146 may generate, search, or change a database to be used in at least one of the application 1170. The package manager 1147 may manage installation or update of an application distributed by a type of a package file.

The connectivity manager 1148 may manage, for example, wireless connection such as Wi-Fi connection or BT connection, and the like. The notification manager 1149 may display or notify events, such as an arrival message, an appointment, and proximity notification, by a method which is not disturbed to the user. The location manager 1150 may manage location information of the electronic device. The graphic manager 1151 may manage a graphic effect to be provided to the user or a user interface (UI) related to the graphic effect. The security manager 1152 may provide all security functions utilized for system security or user authentication, and the like. According to an embodiment of the present disclosure, when the electronic device (e.g., an electronic device 901 of FIG. 9) has a phone function, the middleware 1130 may further include a telephony manager (not shown) for managing a voice or video communication function of the electronic device.

The middleware 1130 may include a middleware module which configures combinations of various functions of the above-described components. The middleware 1130 may provide a module which specializes according to kinds of OSs to provide a differentiated function. Also, the middleware 1130 may dynamically delete some of old components or may add new components.

The API 1160 (e.g., an API 945 of FIG. 9) may be, for example, a set of API programming functions, and may be provided with different components according to OSs. For example, in case of Android or iOS, one API set may be provided according to platforms. In case of Tizen, two or more API sets may be provided according to platforms.

The application 1170 (e.g., an application program 947 of FIG. 9) may include one or more of, for example, a home application 1171, a dialer application 1172, a short message service/multimedia message service (SMS/MMS) application 1173, an instant message (IM) application 1174, a browser application 1175, a camera application 1176, an alarm application 1177, a contact application 1178, a voice dial application 1179, an e-mail application 1180, a calendar application 1181, a media player application 1182, an album application 1183, a clock application 1184, a payment application 1185, a health care application (e.g., an application for measuring quantity of exercise or blood sugar, and the like), or an environment information application (e.g., an application for providing atmospheric pressure information, humidity information, or temperature information, and the like), and the like.

According to an embodiment of the present disclosure, the application 1170 may include an application (hereinafter, for better understanding and ease of description, referred to as “information exchange application”) for exchanging information between the electronic device (e.g., the electronic device 901 of FIG. 9) and an external electronic device (e.g., the first external electronic device 902 or the second external electronic device 904). The information exchange application may include, for example, a notification relay application for transmitting specific information to the external electronic device or a device management application for managing the external electronic device.

For example, the notification relay application may include a function of transmitting notification information, which is generated by other applications (e.g., the SMS/MMS application, the e-mail application, the health care application, or the environment information application, and the like) of the electronic device, to the external electronic device (e.g., the first external electronic device 902 or the second external electronic device 904). Also, the notification relay application may receive, for example, notification information from the external electronic device, and may provide the received notification information to the user of the electronic device.

The device management application may manage (e.g., install, delete, or update), for example, at least one (e.g., a function of turning on/off the external electronic device itself (or partial components) or a function of adjusting brightness (or resolution) of a display) of functions of the external electronic device (e.g., the first external electronic device 902 or the second external electronic device 904) which communicates with the electronic device, an application which operates in the external electronic device, or a service (e.g., a call service or a message service) provided from the external electronic device.

According to an embodiment of the present disclosure, the application 1170 may include an application (e.g., the health care application of a mobile medical device) which is preset according to attributes of the external electronic device (e.g., the first external electronic device 902 or the second external electronic device 904). According to an embodiment of the present disclosure, the application 1170 may include an application received from the external electronic device (e.g., the server 906, the first external electronic device 902, or the second external electronic device 904). According to an embodiment of the present disclosure, the application 1170 may include a preloaded application or a third party application which may be downloaded from a server. Names of the components of the program module 1110 according to various embodiments of the present disclosure may differ according to kinds of OSs.

According to various embodiments of the present disclosure, at least part of the program module 1110 may be implemented with software, firmware, hardware, or at least two or more combinations thereof. At least part of the program module 1110 may be implemented (e.g., executed) by, for example, a processor (e.g., a processor 1010). At least part of the program module 1110 may include, for example, a module, a program, a routine, sets of instructions, or a process, and the like for performing one or more functions.

The term “module” used herein may represent, for example, a unit including one of hardware, software and firmware or a combination thereof. The term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” may include at least one of an application-specific integrated circuit (ASIC) chip, a field-programmable gate array (FPGA), and a programmable-logic device for performing some operations, which are known or will be developed.

At least a part of devices (e.g., modules or functions thereof) or methods (e.g., operations) according to various embodiments of the present disclosure may be implemented as instructions stored in a computer-readable storage medium in the form of a program module. In the case where the instructions are performed by a processor (e.g., the processor 920), the processor may perform functions corresponding to the instructions. The computer-readable storage medium may be, for example, the memory 930.

A computer-readable recording medium may include a hard disk, a floppy disk, a magnetic medium (e.g., a magnetic tape), an optical medium (e.g., CD-ROM, digital versatile disc (DVD)), a magneto-optical medium (e.g., a floptical disk), or a hardware device (e.g., a ROM, a RAM, a flash memory, or the like). The program instructions may include machine language codes generated by compilers and high-level language codes that can be executed by computers using interpreters. The above-mentioned hardware device may be configured to be operated as one or more software modules for performing operations of various embodiments of the present disclosure and vice versa.

A module or a program module according to various embodiments may be composed of single entity or a plurality of entities, a part of the above-described sub-components may be omitted, or other sub-components may be further included. According to various embodiments, operations executed by modules, program modules, or other components may be executed by a successive method, a parallel method, a repeated method, or a heuristic method, or at least one part of operations may be executed in different sequences or omitted. Alternatively, other operations may be added.

While the present disclosure has been shown and described with reference to certain embodiments thereof, it will be understood by those skilled in the art that various changes in form and details may be made therein without departing from the scope of the present disclosure. Therefore, the scope of the present disclosure should not be defined as being limited to the embodiments, but should be defined by the appended claims and equivalents thereof.

1. An electronic device included in at least one area inside a vehicle, the electronic device comprising:
a display having at least one area including a flexible characteristic;
a memory configured to store at least one application program;
an actuator module configured to support shape deformation of the at least one area of the display; and
a processor electrically connected to the display, the memory, and the actuator module,
wherein the processor:
determines a position of at least one user in the vehicle; and
performs control to deform the at least one area of the display in a direction corresponding to the position of the user, when a specified requirement is satisfied with regard to the shape deformation of the at least one area of the display.

2. The electronic device of claim 1, wherein the processor controls the shape deformation of the at least one area of the display when a first requirement that at least one piece of content is controlled to be played on the display by the at least one user, a second requirement that the at least one piece of content controlled to be played includes visual information, and a third requirement that manual driving is performed by the at least one user with regard to travel of the vehicle are satisfied.

3. The electronic device of claim 1, wherein the processor performs control to return the deformed display to a shape before the shape deformation, when autonomous driving is set by the at least one user with regard to travel of the vehicle after the at least one area of the display is deformed.

4. The electronic device of claim 1, wherein the processor determines a property of contents controlled to be played by a first user, when the first user relevant to travel of the vehicle is in the vehicle, and the processor performs control to deform the at least one area of the display in a direction corresponding to a position of the first user, when the property of the contents is related to the travel of the vehicle.

5. The electronic device of claim 4, wherein the processor performs control to divide a screen area of the display into a first virtual area and a second virtual area.

6. The electronic device of claim 5, wherein the processor controls the division of the first virtual area and the second virtual area to cause the first virtual area corresponding to the position of the first user to be larger in size than the second virtual area.

7. The electronic device of claim 5, wherein the processor controls the actuator module to deform a boundary between the first virtual area and the second virtual area into a specified shape.

8. The electronic device of claim 1, wherein the processor determines properties of contents controlled to be played by a plurality of second users and performs control to divide a screen area of the display into a plurality of virtual areas, based on the determination of the properties, when the plurality of second users are in the vehicle.

9. The electronic device of claim 8, wherein the processor controls the division of the plurality of virtual areas to cause a virtual area corresponding to first contents to be larger in size than virtual areas corresponding to the other contents, when the first contents related to travel of the vehicle are included in the contents controlled to be played by the plurality of second users.

10. The electronic device of claim 8, wherein the processor controls the division of the plurality of virtual areas to cause a virtual area corresponding to first contents to be larger in size than virtual areas corresponding to the other contents, when the contents controlled to be played by the plurality of second users are irrelevant to travel of the vehicle and include the first contents related to a specified resolution.

11. The electronic device of claim 1, wherein the processor determines properties of contents controlled to be played by a plurality of second users and performs control to output a sound for specific contents, based on the determination of the properties, when the plurality of second users are in the vehicle.

12. The electronic device of claim 1, wherein the processor performs control to deform at least one area of the display corresponding to a control interface in a direction corresponding to a position of a first user, when the first user relevant to travel of the vehicle is in the vehicle and the control interface is displayed on the display.

13. The electronic device of claim 1, wherein the processor controls the shape deformation of the at least one area of the display to cause a first area of the display corresponding to a control interface to form a specified slope with a second area other than the first area, when the control interface is displayed on the display.

14. The electronic device of claim 1, wherein the processor performs control to deform at least one area of the display corresponding to a control interface in a direction corresponding to a position of a user that is irrelevant to travel of the vehicle among a plurality of second users, when the plurality of second users are in the vehicle and the control interface is displayed on the display.

15. A vehicle comprising an electronic device in at least one area of the vehicle, wherein the electronic device includes:
a display having at least one area including a flexible characteristic;
a memory configured to store at least one application program;
an actuator module configured to support shape deformation of the at least one area of the display; and
a processor electrically connected to the display, the memory, and the actuator module, and
wherein the processor:
determines a position of at least one user in the vehicle; and
performs control to deform the at least one area of the display in a direction corresponding to the position of the user, when a specified requirement is satisfied with regard to the shape deformation of the at least one area of the display.
